(19) United States
(12) Patent Application Publication
(10) Pub. No.: US 2011/0135416 A1
(43) Pub. Date: Jun. 9, 2011

(54) SPINDLE APPARATUS FOR RECEIVING AND DRIVING A TOOL HOLDER

(75) Inventors: Timothy Andrew Fry, Belmont, NC (US); Axel Begemann, Lemgo (DE); Malte Schnepel, Espelkamp (DE); James Allen McKinney, Dallas, NC (US); Douglas Alan Gholson, Dallas, NC (US)

(73) Assignee: Precision Drive Systems, LLC, Bessemer City, NC (US)

(21) Appl. No.: 12/941,186

(22) Filed: Nov. 8, 2010

Related U.S. Application Data
(60) Provisional application No. 61/283,488, filed on Dec. 4, 2009.

(51) Int. Cl. B23Q 5/04

(52) U.S. Cl. 409/232

(57) ABSTRACT

A spindle apparatus for receiving and driving a tool holder, comprises a drive, a shaft coupled to the drive with a forward end of the shaft having a receptor for affixation of a tool holder, and a clamping device supported at the forward end of the shaft for integral driven rotation therewith. The clamping device has a clamping element disposed within the receptor and selectively actuable between an active position for retaining the tool holder and an inactive position for inserting and releasing the tool holder. An actuator is operatively connected with the clamping device for controlling movement of the clamping element between the active and inactive positions. The actuator is disposed adjacent the forward end of the shaft in surrounding relation thereto, which facilitates a particularly compact, efficient and reliable design.

### CROSS-REFERENCE TO RELATED APPLICATIONS

The present application is entitled to the benefit of, and claims priority from, U.S. Provisional Patent Application Ser. No. 61/283,488, filed Dec. 4, 2009, and entitled “COMPACT INDUSTRIAL ROTATING SPINDLE AND TOOL CHANGING SYSTEM,” the entirety of which is incorporated herein by reference.

### FIELD OF THE INVENTION

The present invention pertains generally to machine tools, and more specifically to methods and apparatus for selectively clamping and releasing a tool or similar device, for example, but without limitation, apparatus for receiving and driving a tool holder via an electric machine spindle.

### BACKGROUND OF THE INVENTION

In various manufacturing industries, electrically operated spindle apparatus are utilized for holding and driving differing machine tools to perform differing machining operations. In such applications, a variety of tools may be needed to transform a raw material workpiece into a finished product, e.g., via cutting, boring, trimming, shaping, polishing, engraving, and/or other manners of machining. Hence, it is desirable if not essential that the spindle apparatus provide for convenient, simplified and quick interchange of differing tools. Often, such spindle apparatus are utilized in a computer controlled machine, such as a robotic apparatus, wherein the spindle apparatus is adapted for the interchange of tools automatically without operator intervention, e.g., via pneumatic, electrical or hydraulic actuation, under a preprogrammed computer control such as a so-called “computer numerically controlled” or “CNC” machine control system. For example, in the woodworking industry, such spindle apparatus may be utilized in a robotic apparatus wherein the spindle apparatus is supported on a robotic arm to be manipulated in relation to a workpiece to be cut, bored, profiled or otherwise machined by one or more tools driven by the spindle apparatus, and also to be manipulated in relation to a tool support carousel or rack for automated interchange of one tool for another.

While conventional spindle apparatus perform satisfactorily in such automated computer controlled machine environments, the known spindle apparatus suffer a number of recognized disadvantages. A representative conventional electric motor spindle apparatus comprises a spindle unit and an actuator unit in combination, in which the spindle unit has an electric motor driven shaft fitted at one end with a clamping assembly to interchangeably accept multiple differing tools or implements, with the actuator unit mounted to the opposite end of the spindle unit from the clamping assembly to open and close the clamping assembly via linear reciprocation of a spring-loaded drawbar extending through the length of the shaft. This form of spindle apparatus is relatively large, bulky and heavy, owing to the assemblage of the spindle and actuator units, making the spindle apparatus unsuitable for use in some installations and applications wherein limited space is available for manipulation of the apparatus. Even in installations in which the known type of spindle apparatus is suitable, the size and weight of the apparatus contributes to slow the motions of the apparatus which must be executed in performing an automated tool exchange procedure. Such spindle apparatus also have a substantial number of moving parts which necessarily present a correspondingly increased need for regular adjustments, tuning and other maintenance, and a commensurate risk of misadjustment of parts and incidence of part failures.

There according exists a recognized need within the machine tool industry for an improved form of spindle apparatus suitable for use in CNC and other machines to perform automated interchange of multiple tools.

### SUMMARY OF THE INVENTION

It is accordingly an object of the present invention to improve upon the known forms of spindle apparatus, both as conventionally used for automated tool change operations and non-automated machine tool applications. A further object of the present invention is to address the recognized disadvantages of such known spindle apparatus. Another object of the invention is to provide a spindle apparatus having a smaller dimensional size and lesser bulk and weight, yet with comparable or superior performance, to that of known spindle apparatus A related object of the invention is to provide a spindle apparatus which can be deployed in installations in which conventional spindle apparatus could not heretofore be utilized. A still further object of the invention is to provide a spindle apparatus with a reduced number of operational parts, less frequent required adjustments and other maintenance steps, and enhanced reliability with a lesser incidence of failures and downtime than with known spindle apparatus. A more specific object of the invention is to provide a spindle apparatus which eliminates the use of a hollow shaft, a spring-loaded drawbar and a distal-mounted actuator unit. It is another object of the invention to provide a spindle apparatus that may be adapted for uses in other machines than electric spindles, such as standard electric motors, belt driven spindles, or robotic arms.

Briefly summarized, the present invention provides a spindle apparatus for receiving and driving a tool holder, which basically comprises a drive, a shaft coupled to the drive with one end of the shaft (herein referred to as the forward end) having a receptor configured for affixation of a tool holder, and a clamping device supported at the forward end of the shaft for integral driven rotation therewith. The clamping device has a clamping element disposed within the receptor and selectively actuable between an active position for retaining the tool holder and an inactive position for inserting and releasing the tool holder. An actuator is operatively connected with the clamping device for controlling movement of the clamping element between the active and inactive positions. According to the present invention, the actuator is disposed in surrounding relation to the shaft adjacent the same forward end of the shaft as the clamping device.

in accordance with a preferred embodiment of the invention, the shaft has an axial bore in its forward end in communication with the receptor, and the clamping device comprises a clamp housing disposed within the axial bore and a reciprocable bolt disposed within the clamp housing and operatively connected with the clamping element for moving the clamping element between the active and inactive positions via reciprocation of the bolt. The shaft includes a radial opening therethrough, and the actuator includes a connecting pin extending through the radial opening into engagement with the reciprocable bolt of the clamping device. The pin is disposed for access from exteriorly of the apparatus for selective disconnection of the pin from the clamping device to permit removal of the clamping device outwardly through the axial bore in the shaft at its forward end.

The shaft is preferably supported at its forward end by a front bearing arrangement and at the opposite end of the shaft by a rear bearing arrangement, with the actuator being disposed adjacent the front bearing arrangement. The shaft may preferably be a substantially solid shaft.

In a preferred embodiment, the actuator comprises a first piston disposed coaxially about the shaft in fixed relation thereto and a second piston disposed coaxially about the shaft for axial movement toward and away from the first piston, with the second piston being connected to the clamping device through a radial opening in the shaft. The actuator may include a connecting pin extending through the radial opening into engagement with the clamping device. A spindle housing preferably contains the drive, the shaft, the clamping device and the actuator, with the housing having an opening therein for access to the connecting pin for disconnection of the pin from the clamping device to permit removal of the clamping device outwardly through the forward end of the shaft.

As will thus be understood, the spindle apparatus of the present invention is designed to be used in a machine in a manufacturing or industrial environment wherein an automated tool change process is utilized to interchange different tools used with the machine rapidly and without human intervention. A computer controlled machining center or a robotic arm is a typical form of such a manufacturing or industrial setting for the present apparatus, in which the machining center or robot moves a workpiece and/or the spindle apparatus relative to the other to form the workpiece into a desired product, e.g., by cutting, engraving, trimming, shaping, profiling, grinding, polishing, and in many cases a combination of such operations. A variety of forming tools are usually needed to accomplish such a manufacturing operation. In a preferred embodiment, the spindle apparatus may be powered by compressed air and electricity, controlled via sensors operating in conjunction with a Computer Numerically Controlled (CNC) machine control system. Additional variations of the design can eliminate one or more of these requirements. The present apparatus may also be used in non-automated installations and in applications outside of machining centers or robotics. One example of such an alternative installation would be a through feed cutting machine such as a molder or tenoner.

### BRIEF DESCRIPTION OF THE DRAWINGS

FIG. 1 is a cross-sectional view of a prior art electric motor spindle apparatus, taken through the lengthwise axis of the apparatus;

FIG. 2 is an enlarged cross-sectional view of the actuator unit of the electric motor spindle apparatus of FIG. 1, also taken through the lengthwise axis thereof;

FIG. 3 is a front end elevational view of one preferred embodiment of electric motor spindle apparatus according to the present invention;

FIG. 4 is a cross-sectional view of the entire electric motor spindle apparatus of FIG. 3, taken along line 4-4 thereof through the full lengthwise extent of the axis of the apparatus;

FIG. 5 is a more enlarged cross-sectional view of the forward clamping end of the electric motor spindle apparatus of FIG. 3, taken along line 5-5 thereof through a tool-clamping sensor of the apparatus;

FIG. 6 is another enlarged cross-sectional view, similar to FIG. 5, of the forward clamping end of the electric motor spindle apparatus of FIG. 3, taken along line 6-6 thereof through a spindle rotation sensor of the apparatus;

FIG. 7 is another enlarged cross-sectional view of the forward clamping end of the electric motor spindle apparatus of FIG. 3, also taken along line 4-4 thereof with the clamping assembly in an extended non-clamping position for releasing a tool holder and for receiving a new tool holder;

FIG. 8 is another enlarged cross-sectional view, similar to FIG. 7, showing the forward clamping end of the electric motor spindle apparatus of FIG. 3 with the clamping assembly in a retracted clamping position for grasping and retaining a tool holder;

FIGS. 9A and 9B are side elevational and end elevational views, respectively, showing typical overall outer dimensions of a conventional prior art spindle apparatus of the type shown in FIGS. 1 and 2;

FIGS. 10A and 10B are side elevational and end elevational views, respectively, showing typical overall outer dimensions of a spindle apparatus according to the embodiment of the present invention shown in FIGS. 3-8;

FIG. 11 is a vertical cross-sectional view of an alternative design of actuator piston components for the embodiment of the present spindle apparatus of FIGS. 3-8;

FIG. 12 is a vertical cross-sectional view of an alternative design of sensor disc for the embodiment of the present spindle apparatus of FIGS. 3-8;

FIG. 13 is another enlarged cross-sectional view of the forward clamping end of the electric motor spindle apparatus of FIG. 3 depicting the process of removal of the clamping assembly thereof;

FIG. 14 is an enlarged cross-sectional view of the forward clamping end of the electric motor spindle apparatus of another preferred embodiment of electric motor spindle apparatus according to the present invention, with the clamping assembly in an extended non-clamping position for releasing a tool holder and for receiving a new tool holder; and

FIG. 15 is another enlarged cross-sectional view, similar to FIG. 14, showing the forward clamping end of the electric motor spindle apparatus of FIG. 14 with the clamping assembly in a retracted clamping position for grasping and retaining a tool holder;

### DETAILED DESCRIPTION OF THE PREFERRED EMBODIMENTS

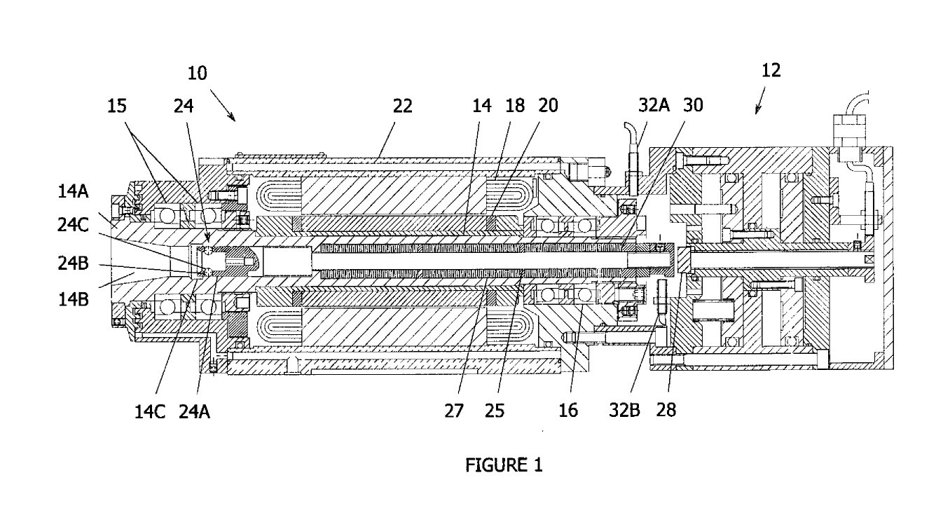

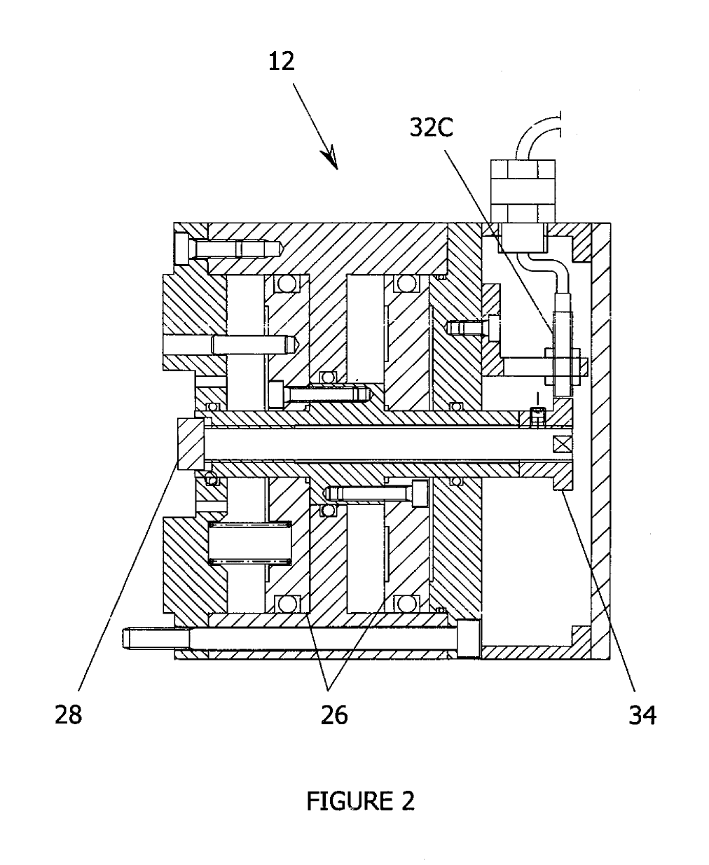

Referring now to the accompanying drawings and initially to FIGS. 1 and 2, a typical conventional prior art electric motor spindle apparatus of the above-described type equipped for selective automated tool changing operations basically comprises an electric motor spindle 10 in combination with an actuator 12. The spindle 10 includes a shaft 14 rotatably supported at its opposite ends via front bearings 15 and rear bearings 16, with an electric motor comprised of a stator 18 and a rotor 20 surrounding the shaft 14 between the bearings 15, 16 to drive rotation of the shaft 14. A main housing 22 encloses and supports the assembly of the shaft 14, bearings 15, 16, and the electric motor 18, 20. A working end 14A of the shaft 14 opens outwardly from one end of the housing 22 (at the leftward end of the housing as viewed in FIG. 1) and is configured to receive a tool (not shown) to be driven via the shaft 14. For automatic tool change applications of the spindle/actuator apparatus, the tapered end opening 14B in the working end 14A of the shaft 14 is configured, e.g., in the form of a tapered end opening 14B in the shaft 14, to mate with the uniform geometry of an interchangeable tool holder (not shown).

The shaft 14 is hollow and interiorly supports a selectively actuable clamping assembly 24 adjacent the working end 14A of the shaft 14 for grasping the interchangeable tool holder in order to provide a secure operational connection between the tool holder and the shaft 14. Several types of clamping assemblies are commercially available to grasp the interchangeable tool holder. The particular structure and method of operation for such clamping assemblies vary, but have in common the capability to peripherally grasp and pull the tool holder axially into the working end 14A of the shaft 14 so as to securely retain the tool holder for unitary rotation with the shaft 14. FIG. 1 depicts one of the most common types of such a clamping assembly 24 in the form of a stub shaft 24A having an axial recess 24B in its forward end with a set of engagement balls 24C supported in radial bores surrounding the recess for movement into and out of the recess 24B. The stub shaft 24A is affixed integrally to the forward end of a drawbar 25, essentially a slender rod that is supported within the spindle shaft 14 to extend through the full length of its hollow interior of the spindle shaft 14 for slidable axial movement relative to the shaft 14. The distal end of the drawbar extends outwardly from the distal end of the shaft 14. A spring, or set of springs, 27 encircle the drawbar 25 within the shaft 14 to extend between an abutment against the shaft 14 adjacent the clamping assembly 24 and an abutment against a flange 30 adjacent the distal end of the drawbar 25 opposite the clamping assembly 24. In this manner, the spring 27 normally acts axially against the flange 30 of the drawbar 25 to urge the drawbar 25 rearwardly within the shaft 14 away from its working end 14A and, in turn, to pull the clamping assembly 24 inwardly within the working end 14A of the shaft 14. Alternatively, the slidable disposition of the drawbar 25 within the shaft 14 enables the application of an axial sliding force against the exposed distal end of the drawbar 25 and against the biasing force of the spring 27 thereby to compress the spring 27 and extend the drawbar 25 forwardly within the shaft 14 so as to extend the clamping assembly 24 into the end opening 14B of the shaft 14. As seen in FIG. 1, the end opening 14B is formed with an annular expansion zone 14C forwardly of the disposition of the clamping assembly 24 as normally withdrawn under the force of the spring 27 which permits the clamping balls 24C to move radially outwardly from the recess 24B when the drawbar 25 and the clamping assembly 24 are thusly extended.

Such forward opening movements and rearward closing movements of the drawbar 25 and the clamping assembly 24 are controlled by the actuator 12, indicated only generally in FIG. 1, but in a more detailed cross-section in FIG. 2. The actuator 12 is mounted to the spindle housing 22 at the distal end of the spindle 10 opposite the clamping assembly 24 at the working end 14A of the shaft 14. The actuator 12 basically is comprised of one or more reciprocable pistons 26 connected to a bolt 28 extending axially through the pistons 26 to reciprocate integrally with the pistons 26. In the embodiment of the actuator 12 shown in FIGS. 1 and 2, the actuator 12 is adapted to be operated pneumatically to reciprocate the assembly of the pistons 26 and the bolt 28, but it is also known to employ actuators powered by electricity or hydraulic pressure. A leading end of the bolt 28 projects forwardly from the actuator 12 in axial alignment with the exposed rearwardly-extending end of the drawbar 25. The pistons 26 are supported to travel within the actuator 12 between a fully retracted inactive position, shown in FIGS. 1 and 2, wherein the leading end of the bolt 28 is spaced rearwardly out of contact with the drawbar 25, thereby permitting the spring 27 to fully retract the drawbar 25 and the clamping assembly 24 within the shaft 14, and a forwardly-extended position wherein the bolt 28 contacts and slidably advances the drawbar 25 forwardly within the shaft 14 against the biasing force of the spring 27 sufficiently to move the retaining balls 24C of the clamping assembly 24 into the expansion zone 14C.

As previously noted, the tool holder is an interchangeable part which has a geometric configuration that mates with the geometric configuration of the tapered end opening 14B of the working end 14A of the shaft 14 and the geometric configuration of the recessed end opening 24B of the clamping assembly 24. The tool holder is itself configured to rigidly and integrally hold a tool or like working implement, e.g. a cutting tool element, whereby the term ‘tool’ is often used to identify the subassembly of the tool element and the tool holder collectively. The mated tapering configuration of the shaft opening 14B and the tool holder facilitate accurate, repeatable, and secure location and seating of the tool holder. Typically, the tool holder is formed with a drive key configured to be engaged by the balls 24C of the clamping assembly 24. Thus, when the bolt 28 and, in turn, the drawbar 25, are advanced by the actuator 12 to extend the clamping assembly 24 into expansion zone 14C of the working end 14A of the shaft 14, the engagement balls 24C are unconstrained to move radially outwardly whereby a tool holder may be inserted into or released from the clamping assembly 24. Then, when the bolt 28 is withdrawn allowing the springs 27 to retract the drawbar 25, the engagement balls 24C are forced to move radially inwardly into engagement with the drive key of the tool holder, thereby grasping the tool holder and pulling it into the working end 14A of the shaft 14. In this manner, the clamping assembly 24, together with the frictional engagement between the mating surfaces of the shaft and the tool holder, is effective to transmit the rotational torque of the shaft 14 generated by the electric motor 18, 20 to the tool holder.

The positions of the assembly of the actuator pistons 26 and bolt 28, and in turn the positions of the clamping assembly 24, are monitored by electrical sensors 32 which communicate with the CNC machine control system. For example, typical sensors 32 may be commercially available, non-contact electronic devices capable of detecting the presence or absence of a material within a predetermined recognition range of the sensor. Generally, one sensor 32A is disposed to monitor a rotating component of the spindle 10 to determine if the spindle 10 is rotating or stopped. One or two sensors 32B are disposed to monitor the end of the drawbar 25 to determine the presence or absence of a tool as indicated by the extended or retracted position of the drawbar 25. One or more additional sensors may be disposed within the actuator 12 to monitor the extended or retracted disposition o the pistons 26 and the bolt 28, e.g., a sensor 32C disposed to detect the location of the rearward end of the bolt 28, e.g., via a sensor disc 34 affixed to the end of the bolt 28, to determine whether the pistons 26 and bolt 28 are in their forward or rearward position.

The conventional operation of the spindle and actuator apparatus to accomplish a tool change process in a typical CNC machine may thus be understood. First, the CNC control system deactuates the electric motor 18, 20 to bring the spindle 10 to a standstill, which is confirmed and communicated to the CNC control system via the spindle rotation sensor 32A. The machine then manipulates the spindle and actuator apparatus 10, 12 into a tool exchange position relative to a storage magazine, carousel, or rack that holds multiple interchangeable tools, whereupon the actuator 12 is energized to begin the tool change process by extending the actuator pistons 26 forwardly and in turn extending the drawbar 25 against the biasing force of the spring 27, thereby extending the clamping assembly 24 to relieve the engagement of the balls 24C on the tool holder so as to release the tool onto an empty storage location on the magazine/carousel/rack. After depositing the released tool, the machine moves the spindle and actuator apparatus 10, 12 away from the released tool and into position to accept and engage a different tool. The pneumatic force acting on the actuator pistons 26 is released to allow the pistons 26 and the drawbar 25 to return to their respective retracted positions under the biasing force of the spring 27. In turn, the clamping assembly 24 is retracted within the working end 14A of the shaft 14, thereby grasping and drawing the new tool into clamped position within the clamping assembly 24. The sensor 32B confirms when the drawbar 25 has returned to its fully retracted position, indicating that the tool holder is correctly clamped, whereupon the CNC control system re-energizes the electric motor 18, 20 to resume driven rotation of the spindle, thereby completing the tool change sequence.

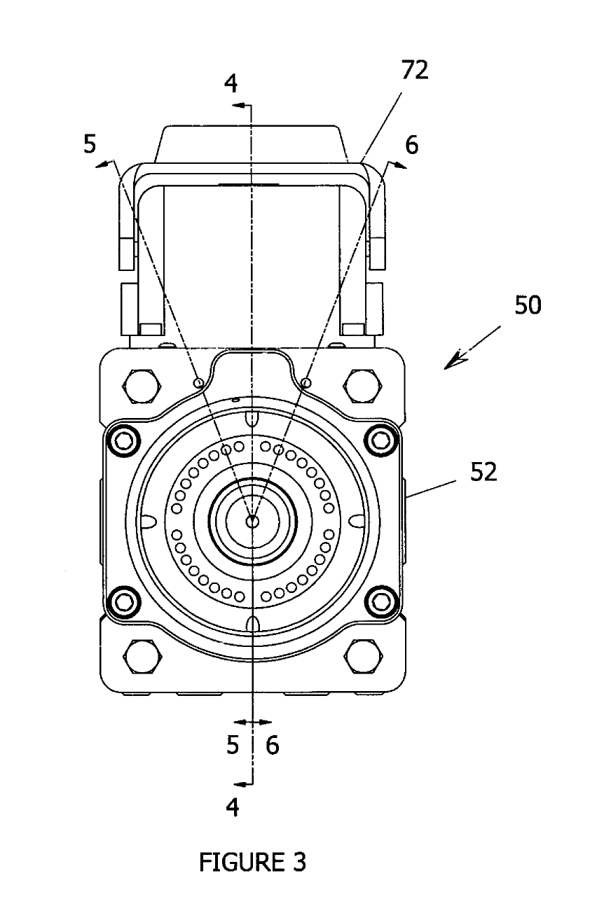

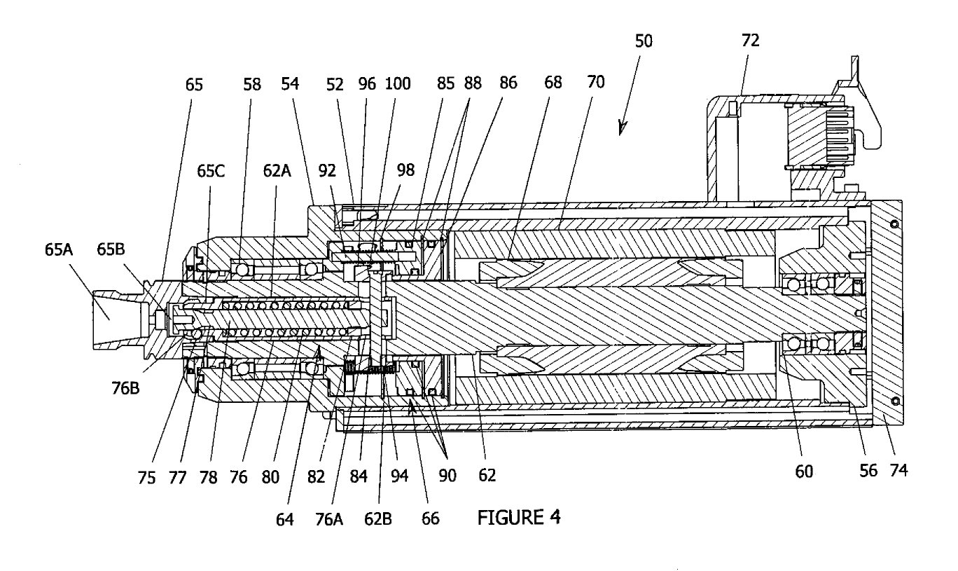

Turning now to FIGS. 3-8, an electric motor spindle apparatus according to one preferred embodiment of the present invention is indicated generally at 50 and will be recognized to differ substantially in both structure and operation to the known prior art automatic tool change spindle apparatus of FIGS. 1 and 2. The spindle apparatus 50 basically comprises an elongate main spindle housing 52 to opposite ends of which are affixed a front bearing housing 54 and a rear bearing housing 56 having front and rear ball bearing sets 58, 60, respectively, for rotationally supporting a longitudinal shaft 62 extending centrally through the interior of the main housing 52. The shaft 62 is a solid body except only that the forward end of the shaft 62 has an axial cavity 62A serving as a receptor in which is affixed a clamping device, such as clamping assembly 64, selectively actuable for clamped engagement and unclamped release of a mating tool holder 65, all as more fully described hereinafter. An actuator, such as the actuator assembly generally indicated at 66, is supported within the front bearing housing 54 to surround the forward end of the shaft 62 immediately rearwardly of the front bearing set 58 and is connected with the clamping assembly 64 for actuating clamping and unclamping thereof, as also more fully described hereinafter. Rotational driving force is imparted to the shaft 62 by an electric motor comprised of a rotor 68 fixed about the shaft 62 and a stator 70 fixed stationarily within the main housing 52 in surrounding relation to the rotor 68. A connector unit 72 is affixed to the exterior of the housing 52 adjacent its rearward end to supply operating electrical power to the electric motor and compressed air for pneumatic operation of the actuator assembly 66. The distal rearward end of the main housing is enclosed by a cover plate 74.

The clamping assembly 64 comprises a hollow clamping housing 76 fitted within the cavity 62A of the spindle shaft 62 and secured in place by mating threads formed on the inserted end of the clamping housing 76 and on the interior end on the cavity 62A, whereby the clamping housing 76 rotates integrally with the shaft 62. The forward end of the clamping housing 76 faces outwardly from the forward end of the shaft 62 and is formed with an axial opening into the hollow interior of the clamping housing 76, through which a clamping bolt 78 extends slidably into the clamping housing 76. The clamping bolt 78 is surrounded by a coil spring 80 extending between an interior shoulder within the clamping housing 76 and a tensioning nut 82 threaded about the bolt 78, whereby the spring 80 urges the bolt 78 inwardly within the clamping housing 76. The interior end of the clamping bolt 78 has a bore formed diametrically therethrough which receives a high strength pin 84 extending radially outwardly through aligned slots 76A, 62B in the clamping housing 76 and in the shaft 62, respectively, for connecting the clamping bolt 78 with the actuator assembly 66 to transmit clamping and unclamping movements to the clamping assembly 64, as more fully described below.

The forward end of the clamping housing 76 is formed as a narrowed neck portion 76B of reduced diameter about which are formed a plurality of circular openings each containing a clamping ball 75 movable radially inwardly and outwardly within the respective opening. The forward end of the clamping bolt 78 radially inwardly adjacent the neck portion 76B is formed with an annular recess 77 disposed to allow the balls 75 to move radially inwardly into the recess 77 when the bolt 78 slides forwardly in the clamping housing 76. The forward end of the recess 77 is formed with an outwardly tapering surface disposed to direct the balls 75 radially outwardly within their openings when the clamping bolt 78 slides rearwardly within the clamping housing 76.

This arrangement of the clamping assembly 64 is thereby effective for selectively grasping and releasing the tool holder 65 under the selective actuation of the actuator assembly 64 as described below. The tool holder 65 is formed in its forward end with a recess 65A configured to receive any of a plurality of like-formed interchangeable tool elements (not shown), as is conventional. The opposite rearward end of the tool holder 65 is formed with a peripheral external taper mated to the internal taper of the cavity 62A of the shaft 62. The rearward end of the tool holder 65 is formed interiorly with a recess 65B encircled by an annular lip 65C adapted to be engaged and grasped rigidly by the clamping balls 75 when moved and held in their radially outward position and to be disengageable from the clamping balls 75 when moved into their radially inward position relative to the clamping housing 76.

The actuator assembly 66 comprises annular front and rear pistons 85, 86 disposed within the front bearing housing 54 in surrounding relation to the spindle shaft 62. The rear piston 86 is closely fitted around the shaft 62 immediately forwardly of the electric motor 68, 70 and is fixed stationarily in place to the front bearing housing 54 by retaining rings 88. The rear actuator piston 86 has a forwardly projecting hub portion about which the front piston 85 is fitted for sliding axial movement toward and away from the rear piston 86 whereby the front piston 85 is isolated from the rotating shaft and also can be sealed relative to the rear piston. A port (not shown) is machined in the front bearing housing 54 to connect a source of compressed air, delivered via the connector 72, to the spacing between the front and rear pistons 85, 86 for actuating movement of the front piston 85 away from the rear piston 86. Sealing rings 90 are fitted about the inward and outward surfaces of the front piston 85 and about the outer surface of the rear piston 86 to seal the pistons relative to each other and to the front bearing housing 54, whereby the spacing between the pistons 85, 86 is airtight to contain the pressurized air. Several dowel pins 92 extend axially between bores formed in the forward face of the front piston 85 and the front bearing set 58 to serve as guides for reciprocating movement of the front piston 85, and coil springs 94 surround the dowel pins 92 to urge the front piston 85 toward the rear piston 86 into a home position adjacent thereto. An annular sensor disc 96 surrounds the shaft 62 in slidable relation thereto forwardly of the front piston 85 and is fixed to the connecting pin 84 preferably by threaded engagement of the pin 84 in the body of the sensor disc 96 to connect the actuator assembly 66 to the clamping assembly 64.

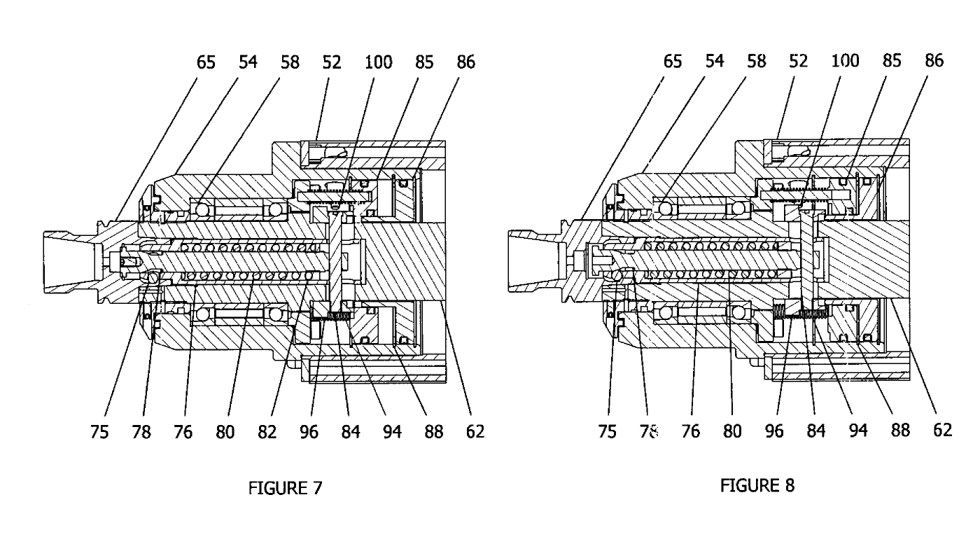

Thus, the actuator assembly 66 operates the clamping assembly 64 in the following manner, best understood with reference to FIGS. 7 and 8. In normal operation of the spindle apparatus 50, the actuator assembly 66 is deactuated, whereby the front piston 85 resides in its home position immediately adjacent the rear piston under the influence of the springs 94, as depicted in FIG. 8. The clamping assembly 64 is therefore disposed with its clamping bolt 78 withdrawn rearwardly relative to the clamping housing 76, thereby causing the clamping balls to be engaged and moved outwardly by the tapered forward end surface of the clamping bolt recess 77 so as to engage the tool holder 65 with radial and axial force inwardly of its rearward lip 65C to grasp it rigidly as a unit with the shaft 62 to rotate integrally therewith under the driving force of the motor 68, 70. When it is desired to exchange the tool holder 65 for another tool holder, the motor 68, 70 is denergized to bring the shaft 62 to a standstill, and thereupon the actuator assembly 66 is actuated by delivering compressed air into the space between the front and rear pistons 85, 86 causing the front piston 85 to move forwardly away from the rear piston 86 and, in turn, compressing the springs 94, as depicted in FIG. 7. As the front piston 85 moves forwardly, the sensor disc 96 also slides forwardly, in turn moving the connecting pin 84 and the clamping bolt 78 forwardly. When the annular recess 77 in the forward end of the clamping bolt 78 advances into adjacency to the clamping balls 75, the clamping force exerted by the balls 75 against the tool holder 65 is relieved and the balls 75 are permitted to move radially into the annular recess 77 sufficiently that the tool holder 65 may be withdrawn forwardly from the shaft 62 and a new tool holder inserted into the tapered front end of the shaft 62. Thereupon, the source of the compressed air is deactivated, allowing the compressed spring force of the springs 94 to return the front piston 85 to its home position and simultaneously allowing the clamping bolt 78 to retract within the clamping housing 76 as the compressed spring force of the clamping spring 80 is relieved. The clamping balls 75 are thereby engaged again by the tapered surface at the forward end of the recess 77 in the clamping bolt 78, causing the balls 75 to be forced radially outwardly into clamping engagement with the replacement tool holder.

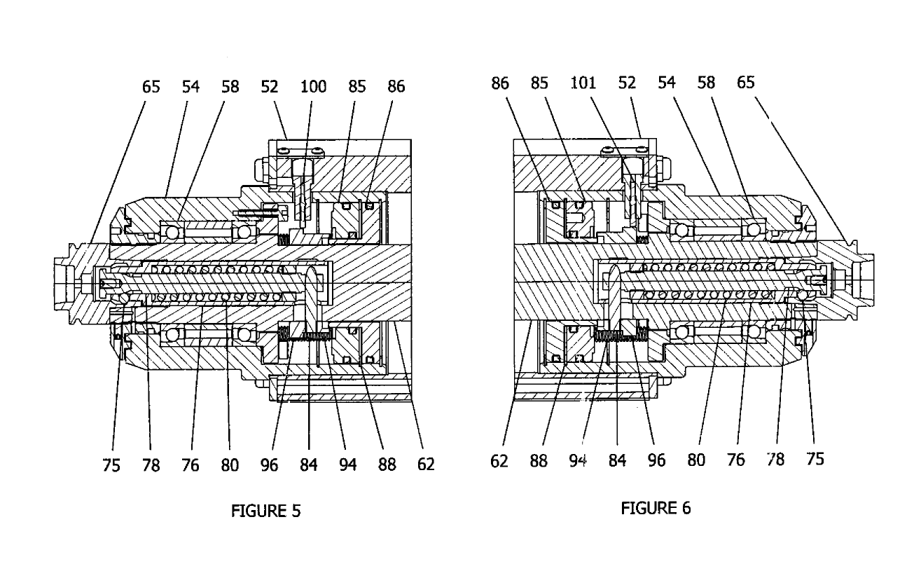

The actuator assembly 66 preferably includes safety features to control the limits of the forward and rearward movements of the front piston 85. First, a retaining ring 98 is fitted within the front bearing housing 54 to define an engagement stop to be contacted by the front piston 85 at the forward limit of its travel and thereby to prevent excessive spring force from the spring 80 from being transmitted to the front bearing set 58 which could potentially damage the front bearing set 58 under the significant forces created by the actuator assembly 66. In addition, a first electronic proximity sensor 100 (see FIG. 5) is fitted radially through the spindle body 52 and the front bearing housing 54 in a position to detect whether the sensor disc 96 is in its normal rearward clamping position and to generate a corresponding control signal which may be transmitted via the connector 72, e.g., to the CNC machine in which the spindle apparatus 50 is installed. A second electronic proximity sensor 101 (see FIG. 6) is similarly fitted radially through the spindle body 52 and the front bearing housing 54 in a position to detect whether the sensor disc 96 is in its forward position indicating that the tool holder has been released for replacement and to generate a corresponding control signal for transmission via the connector 72. Another sensor (not shown) may be provided at a suitable position, e.g., in the rear bearing housing 56 behind the rear bearing set 60 to detect whether the shaft 62 is under rotation.

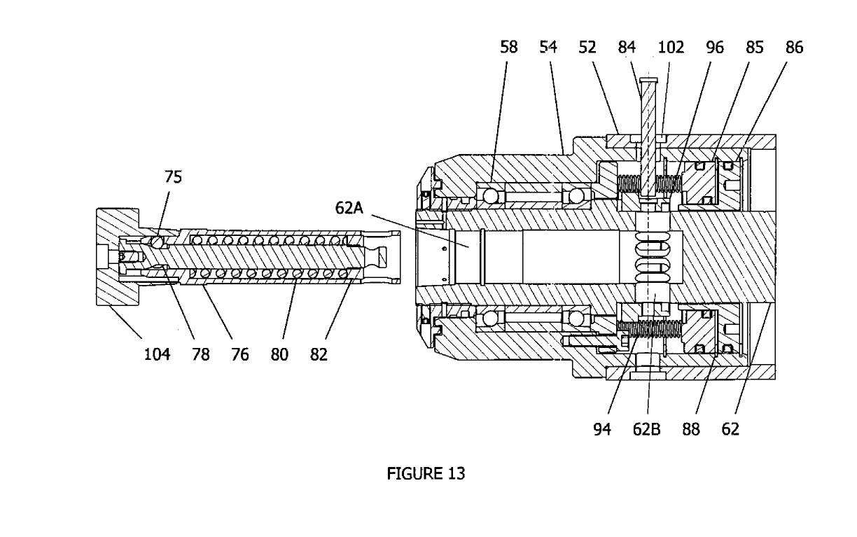

The manner in which the present spindle apparatus 50 accomplishes the connection between the clamping assembly 64 and the actuator assembly 66 via the connecting pin 84 provides a significant and distinct improvement over prior art spindle designs by allowing the entire clamping assembly 64 to be selectively removed from the front end of the spindle apparatus 50 without disassembling or disturbing any other components. As shown in FIG. 13, an opening 102 is provided radially through the side of the spindle body 52 at the axial location of the pin 84 when actuator assembly is in its retracted home position, whereby the pin 84 can be unthreaded from the sensor disc 96 and removed outwardly from the spindle apparatus 50 through the opening 102 when desired. When the pin 84 is removed, the clamping housing 76 can be unthreaded from the spindle shaft 62 whereupon the entire clamping assembly 64 can then be quickly and easily withdrawn and replaced as a unit, enabling the spindle apparatus 50 to be promptly returned to operation, with minimal downtime and minimal impact to production efficiency. An assembly tool 104 matable with the forward end of the clamping housing 76 may be provided to accomplish insertion and removal of the clamping assembly into proper positioning within the cavity 62A in the shaft 62 so as thereby to aid in insertion and removal of the connecting pin 84.

Another significant feature of the present spindle apparatus 50 is its ability for fine adjustments to be made to the clamping assembly 64. The threaded mounting of the clamping housing 76 to the spindle shaft 62 enables the axial positioning of the clamping assembly 64 relative to the stationary components of the spindle apparatus 50 to be finely set upon installation of the clamping assembly 64. To facilitate the necessary connection of the clamping assembly 64 to the actuator assembly 66 via the connecting pin 84 at any such axial position of the clamping assembly 64, the spindle shaft 62 is formed with two or more slots 62B circumferentially spaced about the shaft 62 and the slots 62B are elongated in the axial direction. In this manner, following the threaded adjustment of the positioning of the clamping assembly 64, the connecting pin 84 can be installed through the slots 62B which are exposed at the opening 102. An additional adjustment to the clamping assembly 64 is possible by adjusting the threaded disposition of the spring preload nut 82 along the clamping bolt 78 to selectively increase or decrease the biasing force exerted by the spring 80.

The spindle apparatus of the present invention will thus be recognized to provide a number of significant advantages over conventional spindle apparatus. The disposition of all mechanical components of the actuator assembly 66 at the forward end of the apparatus immediately surrounding the clamping assembly 64 and the forward working end of the shaft 62 substantially reduces the overall size of the spindle apparatus in substantially all dimensions, reduces the number of mechanical components thereby simplifying and reducing manufacture and assembly time and cost, and improves the operational reliability with commensurate reduction of subsequent maintenance cost, as compared to comparable conventional spindle apparatus.

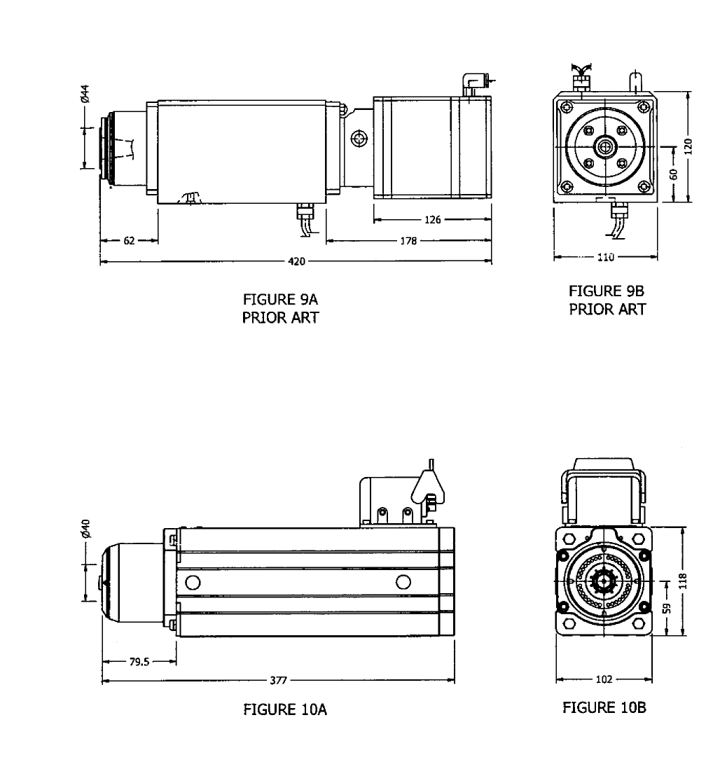

FIGS. 9A, 9B, 10A and 10B illustrate the comparative difference in overall physical size of a typical conventional spindle apparatus (FIGS. 9A, 9B) to a comparable embodiment of the spindle apparatus 50 of the present invention belonging to the same size and class of spindles within the industry. As will be seen, the present spindle apparatus 50 is smaller in every dimension but most notably in the length of the spindles. Specifically, the overall length of the present spindle apparatus is reduced by more than 10% (e.g. from 420 mm to only 377 mm). In general, it is expected in the industry that an increase in spindle power (within the same size range and method of cooling) requires a longer stator, increasing the length of the spindle apparatus. However, the design of the present spindle apparatus of FIGS. 10A and 10B produces 46% more power than the conventional spindle apparatus of FIGS. 9A and 9B, and is still able to achieve more than a 10% (e.g. 43 mm) reduction in overall length. The reduction in overall length is especially significant for applications of the spindle apparatus in certain robotic and advanced CNC machining applications, as a shorter spindle enables the size of part being manufactured to be increased. Additionally, a shorter spindle apparatus is capable of functioning within more restricted dimensions when performing certain machining operations. For example, machining applications that require internal operations (such as the manufacture of housings, gear cases, boat hulls, bath tubs, or similar objects) can be problematic because they require the spindle to perform work on the inside surface of the part, where space is frequently at a premium. The spindle apparatus according to the present invention permits much greater versatility for manufacturing these types of components.

The design of the present spindle apparatus in situating the actuator assembly at the forward end of the apparatus advantageously eliminates the need to employ a hollow spindle shaft with an internal drawbar to actuate a clamping assembly for a tool holder. Spindle drawbar and spring arrangements present inherent difficulties not only in the manufacturing process, but throughout the entire life cycle of the spindle apparatus, and are recognized in the industry to cause a high frequency of spindle failures. Such arrangements require close tolerances to be maintained between the spring, drawbar, and shaft throughout the entire length of the shaft. Especially in the case of the shaft, the high tolerance machining required to create a through hole for a drawbar is expensive and requires specialized boring and internal grinding machinery. Maintaining the proper alignment, clearances, and runout increases the complexity of the initial assembly of the apparatus, and complicates later repair of the spindle apparatus. Spindle balance is also affected by the inherent movement of these large components inside the shaft. In sum, the forward disposition of the actuator assembly and the ability to use a solid spindle shaft in the present apparatus results in simplified and less costly manufacture, better balancing and more reliable operation with less frequent and less costly maintenance of the apparatus in use, and greater productivity through extended cutting tool life and improved work piece surface qualities.

Another advantage accruing from the ability to use a solid spindle shaft is to enable the creation of unique spindle variations that were not possible with the traditional hollow shaft design. For example, a double-ended automatic tool change spindle may be manufactured as one contemplated alternative embodiment of the present spindle apparatus. Such a double-ended spindle design is not possible with existing spindle constructions because the drawbar actuator design requires that an actuator be situated at one end of the hollow spindle shaft.

Spindle maintenance is also considerably improved by the present spindle apparatus by making it possible to remove and replace the clamping assembly without disassembling the spindle or removing it from the CNC machine or robot, as described above. By contrast, in known spindle apparatus designs, it is necessary to disassemble the spindle at least to the point at which the rear bearings may be accessed, so that the drawbar and surrounding spring may be removed through the rear of the spindle. This operation generally requires removing the spindle apparatus from the robotic or CNC machine, removing the actuator, and disassembling any sensors necessary to expose the end of the drawbar. Since the clamping assembly 64 of the present invention can be removed from the forward end of the apparatus, many of the wear prone components that must be periodically replaced can be more quickly and easily exchanged with less apparatus downtime.

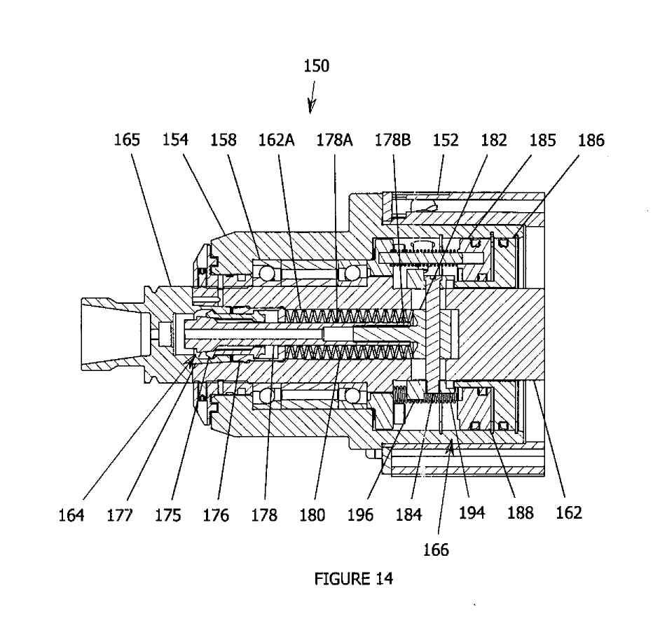

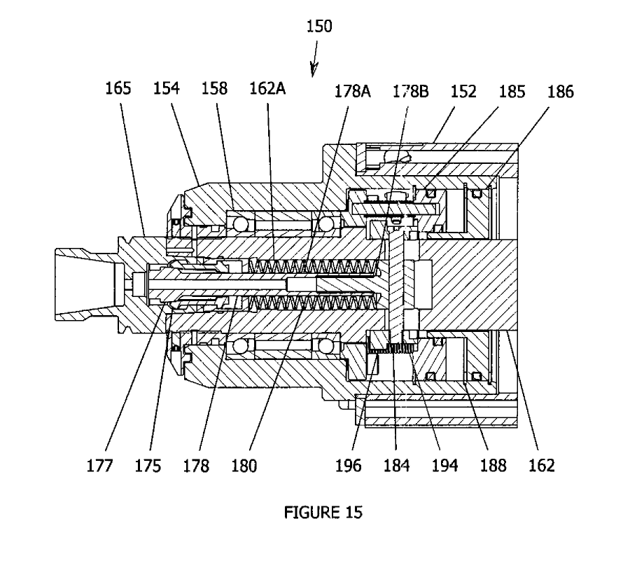

While the present invention has been described hereinabove in relation to one preferred embodiment of the present spindle apparatus, those persons skilled in the relevant art will readily recognize and understand that various alternative embodiments and other variations are possible. For example, the present spindle apparatus may utilize other forms of tool holder clamping assemblies than the ball-type clamping assembly 64 in the embodiment of FIGS. 3-8. Specifically, the spindle apparatus may equally well employ other commercially available clamping systems which utilize fingers or other gripping elements instead of balls, as is depicted as an additional exemplary embodiment in FIGS. 14-15. In FIGS. 14-15, like components that correspond to the components of the spindle apparatus of FIGS. 3-8 are identified by corresponding reference numerals in the 100 series of numerals.

The spindle apparatus of FIGS. 14-15 is designated overall at 150 and includes a main housing 152, front and rear bearing housings with respective bearing sets (only front housing 154 with front bearing set 158 being shown), a solid spindle shaft 162, and an actuator assembly 166 (comprised of front and rear pistons 185, 186, piston retaining rings 188, a sensor disc 196, piston return springs 194, and connecting pin 184), substantially as in the embodiment of FIGS. 3-8. The spindle apparatus 150 differs primarily only in the structure of its clamping assembly 164, specifically in the configuration and arrangement of the clamping housing 176, the clamping bolt 178 and the provision of clamping fingers 175 instead of clamping balls 75. In this embodiment of clamping assembly 164, the clamping housing element 176 is a hollow body of reduced lengthwise dimension fitted rigidly into the forward end of the cavity 162A in the spindle shaft 162 and carries internally a plurality of the clamping fingers 175 in an annular array projecting forwardly through an opening in the front end of the housing 176. The clamping bolt 178 extends slidably through the clamping housing 176 and its clamping fingers 175 and is formed of two bolt elements 178A, 178B threaded together in axial alignment. The rearward bolt element 178B is formed at its rearward end with an enlarged shoulder 182 through which is formed a radial bore to receive the connecting pin 184. The forward end of the bolt element 178B is threaded into a bore formed in the rearward end of the forward bolt element 178A. A spring 180 encircles the clamping bolt 178 between the clamping housing 176 and the shoulder 182, to urge the clamping bolt 178 rearwardly into a home position retracted relative to the clamping housing 176. The threaded connection between the bolt elements 178A, 178B enables a selective preloading of the spring 180. The forward end of the bolt element 178A is formed with a radially enlarged tapering cam surface 177 which acts on the clamping fingers 175 to move them radially outwardly into clamping engagement interiorly of the tool holder 165 when the bolt 178 is withdrawn rearwardly into its home position by the actuator assembly 166 (FIG. 14) and relieves clamping force on the fingers 175 to allow radially inward movement for disengagement of the tool holder 165 when the bolt 178 is extended forwardly by the actuator assembly 166 (FIG. 15).

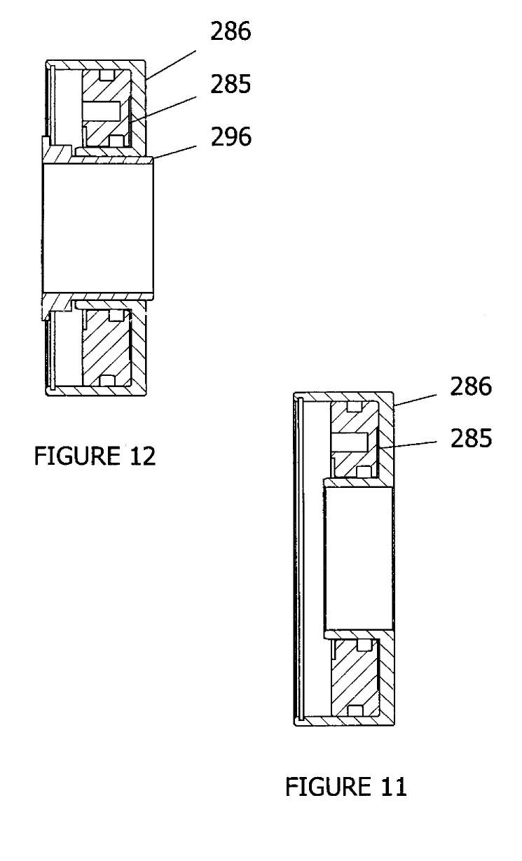

Many other variations of the present spindle apparatus are also possible. For example, it is contemplated that springs 94 may not be required to return the front piston to its home position, but instead the pneumatic actuation of forward piston movement via application of compressed air between the actuator pistons may be switched to application of a vacuum in order to execute rearward return piston movements. Additionally, although compressed air is used in the described embodiments to operate the actuator assembly, hydraulic or electrical power may alternatively be used to operate the actuator assembly. It is additionally contemplated that other configurations of the actuator pistons may be utilized. For example, as illustrated in FIG. 11, the rear actuator piston 286 may be of a configuration to wrap around the inside and outside diameters of the front piston 285 and may then be utilized to perform the additional function of the front bearing housing 54. In such an embodiment, the rear actuator piston 286 can be held in place by fasteners connected to the spindle housing 52.

An alternative arrangement of the actuator assembly and sensor disc is shown in FIG. 12. In this variation, the sensor disc 296 extends through the rear piston 286 toward the rear of the spindle apparatus. The sensor disc 296 could also be located between the rear piston 286 and the shaft 62, which could be advantageous if it is necessary to have additional electrical sensors or an encoder behind the actuator assembly and also could facilitate even more compact spindle designs.

The present invention also is not limited to electric motor spindle apparatus. Since the shaft is solid and all components (actuator, sensors, etc.) necessary to execute automatic tool change operations are consolidated to a forward location relative to the shaft, a much broader range of applications is conceivable. Thus, the invention may be adapted to operate with other machines and power sources by fitting a machine coupling behind the rear piston. For example, the present apparatus could be fitted onto 50/60 Hz standard industrial motors, servo motors, or air motors.

Those persons skilled in the art will thus recognize and understand that the invention is susceptible of broader utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, it is to be understood that the foregoing disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A spindle apparatus for receiving and driving a tool holder, comprising:
a. a drive,
b. a shaft coupled to the drive, one end of the shaft having a receptor configured for affixation of a tool holder,
c. a clamping device supported at said one end of the shaft for integral driven rotation therewith, the clamping device having a clamping element disposed within the receptor and selectively actuable between an active position for retaining the tool holder and an inactive position for inserting and releasing the tool holder, and
d. an actuator operatively connected with the clamping device for controlling movement of the clamping element between the active and inactive positions, the actuator being disposed adjacent said one end of the shaft in surrounding relation thereto.

2. A spindle apparatus for receiving and driving a tool holder according to claim 1, wherein the shaft has an axial bore in said one end in communication with the receptor, and the clamping device comprises a clamp housing disposed within the axial bore and a reciprocable bolt disposed within the clamp housing and operatively connected with the clamping element for moving the clamping element between the active and inactive positions via reciprocation of the bolt.

3. A spindle apparatus for receiving and driving a tool holder according to claim 2, wherein the shaft includes a radial opening therethrough, and the actuator includes a connecting pin extending through the radial opening into engagement with the reciprocable bolt of the clamping device.

4. A spindle apparatus for receiving and driving a tool holder according to claim 3, wherein the pin is disposed for access from exteriorly of the apparatus for selective disconnection of the pin from the clamping device to permit removal of the clamping device outwardly through the axial bore in the shaft at said one end thereof.

5. A spindle apparatus for receiving and driving a tool holder according to claim 1, wherein the shaft is supported at said one end thereof by a front bearing arrangement and at the opposite end of the shaft by a rear bearing arrangement, the actuator being disposed adjacent the front bearing arrangement.

6. A spindle apparatus for receiving and driving a tool holder according to claim 1, wherein the shaft is a substantially solid shaft.

7. A spindle apparatus for receiving and driving a tool holder according to claim 1, wherein the actuator comprises a first piston disposed coaxially about the shaft in fixed relation thereto and a second piston disposed coaxially about the shaft for axial movement toward and away from the first piston, the second piston being connected to the clamping device through a radial opening in the shaft.

8. A spindle apparatus for receiving and driving a tool holder according to claim 7, wherein the actuator includes a connecting pin extending through the radial opening into engagement with the clamping device.

9. A spindle apparatus for receiving and driving a tool holder according to claim 8, further comprising a spindle housing containing the drive, the shaft, the clamping device and the actuator, the housing having an opening therein for access to the connecting pin for disconnection of the pin from the clamping device to permit removal of the clamping device outwardly through said one end of the shaft.
